(19) United States
(12) Patent Application Publication
(10) Pub. No.: US 2018/0363824 A1
(43) Pub. Date: Dec. 20, 2018

(54) HEATABLE MOTOR-VEHICLE PIPELINE AND METHOD FOR PRODUCING A HEATABLE MOTOR-VEHICLE PIPELINE

(71) Applicant: TI AUTOMOTIVE (FULDABRÜCK) GMBH, Fuldabrück (DE)

(72) Inventors: Michael WEISSING, Heidelberg (DE); Andre HÄCKEL, Waldeck (DE)

(21) Appl. No.: 15/753,890

(22) PCT Filed: Aug. 12, 2016
(86) PCT No.: PCT/EP2016/069291

§ 371 Date: May 31, 2018

(30) Foreign Application Priority Data
Aug. 20, 2015 (EP) 15181779.8

(51) Int. Cl. F16L 53/38; F01N 3/20

(52) U.S. Cl. CPC F16L 53/38; F01N 3/2066; F16L 11/127; F01N 2610/10; F01N 2610/1486; F01N 2610/02

(57) ABSTRACT

Heatable motor vehicle conduit for transmission of a fluid medium, wherein the conduit includes an inner channel as well as a tube wall surrounding the inner channel. At least one heating channel extending in the longitudinal direction of the conduit is provided inside the tube wall. At least one heating element extending along the heating channel is disposed in the heating channel. The heating element is surrounded by the inner wall of the heating channel and by the material of the tube wall over at least 85% of its circumference.

### RELATED APPLICATIONS

The present patent document is a 371 of International Application Serial No. PCT/EP2016/069291, filed Aug. 12, 2016, which corresponds to European Application Serial No. 15 181 779.8, filed Aug. 20, 2015, designating the United States and published in English, which is hereby incorporated by reference.

### TECHNICAL FIELD

The invention relates to a heatable motor-vehicle conduit for transmission of a fluid medium, in particular for transmission of a urea solution or an aqueous urea solution, wherein the conduit includes an inner channel for the transmission of the fluid medium as well as a tube wall surrounding the inner channel. Furthermore, the invention also relates to a method for manufacturing such a heatable motor-vehicle conduit—hereinafter instead of the term ‘motor-vehicle conduit,’ the shorter term ‘conduit’ is also used.

### BACKGROUND

Heatable motor-vehicle conduits of the above-mentioned type are known in practice in various embodiments. In particular, heating or electrically heating such conduits is also known in practice. In this context in particular conduits for transmission of an aqueous urea solution are also known from the prior art. Such an aqueous urea solution is used in the context of an SCR system (SCR: selective catalytic reduction) of a motor vehicle. In motor vehicles, especially in motor vehicles with a diesel engine, an SCR system including an SCR catalytic converter is often provided for exhaust treatment. For effective reduction of the nitrogen oxides contained in the exhaust gas of the motor vehicle, the urea solution is added to the exhaust gas before the SCR catalytic converter. Such an aqueous urea solution has the disadvantage that urea freezes and partially crystallizes at temperatures below −11° C. Subsequently a dependable supply of the urea solution can thereby be hindered or even completely blocked. This will result in impairment or prevention of an effective reduction of the nitrogen oxides. In order to avoid such impairments, the motor vehicle conduits for urea solutions can be heated in the known manner. The heating is carried out in particular with the help of electrical heating wires.

Winding or coil-shaped winding of a heating wire onto the outer surface of the conduit is already known from practice. This winding process is first of all relatively time-consuming. In addition, relatively expensive measures for the positioning and fixing of the heating wire are required. Thus it is known to provide shaping elements on the outer surface of the conduit, which shaping elements are for the positioning of the heating wires, or to fix the heating wires, for example, with the help of adhesive tapes. For this purpose a further material consumption and thus also increased cost is required. Often the functionally secure positioning of the heating wire is difficult or insufficient, and due to incorrect positioning or fixing, disadvantageous short circuits can occur in operation of the conduit. In addition, the effectiveness of the heating in the heating wires wound onto the outer surface leaves something to be desired. The heat transfer to the inner channel of the conduit is often not satisfactory. Moreover, heating wires wound onto the outer surface increase the outer diameter of the conduit in an adverse manner. Thus the known measures need improvement.

### BRIEF SUMMARY

One embodiment of the present disclosure teaches a heatable motor-vehicle conduit for transmission of a fluid medium, in particular for transmission of a urea solution or an aqueous urea solution, wherein the conduit includes an inner channel for the transmission of the fluid medium as well as a tube wall surrounding the inner channel, wherein inside the tube wall at least one heating channel is provided extending in the longitudinal direction or essentially in the longitudinal direction of the conduit, wherein in the heating channel at least one heating element is disposed along the heating channel and extending in the longitudinal direction of the conduit or essentially in the longitudinal direction of the conduit, and wherein the heating element is surrounded by the inner wall of the heating channel and by the material of the tube wall over at least 60%, preferably over at least 70%, and more preferably over at least 85% or 90% or 95% of its circumference. It is in the context of the invention that the heating element is surrounded over at least 97%, in particular over 98%, and according to one embodiment over 99% or over 100% of its circumference by the inner wall of the heating channel and by the material of the tube wall. The last-mentioned embodiment having the one-hundred-percent containment is explained in more detail below.

An inventive heating channel—viewed from the at least one heating element accommodated therein—is configured as a hollow channel. The heating channel is preferably completely accommodated in the tube wall and is thus located below the outer circumference of the tube wall. It is recommended that a heating element accommodated in a heating channel is completely accommodated in the tube wall and preferably does not protrude out of the outer surface—in particular not out of a cylindrical outer surface of the tube wall.

According to a particularly preferred embodiment of the present disclsoure, the tube wall including the at least one heating channel or the tube wall accommodating the at least one heating channel, is configured as a single-layer tube wall. This tube wall is expediently comprised of one and the same plastic or polymer material, for example of a polyamide. According to another preferred embodiment the tube wall is multi-layer.

An inventive heating channel or an inventive heating element extends over at least one longitudinal region of the motor-vehicle conduit. The heating channel or the heating element preferably extends over at least 40%, more preferably over at least 50%, and particularly preferably over at least 60% of the length of the conduit.

Furthermore, the inner wall, formed from the material of the tube wall, of a heating channel extends over at least 85%, preferably over at least 90%, more preferably over at least 95%, particularly preferably over at least 97%, and most preferably over at least 98% of the inner circumference of the heating channel. According to one embodiment the mentioned inner wall extends over at least 99% of the inner circumference of the heating channel, and according to an embodiment variant over 100% of the inner circumference of the heating channel.—As recommended, the heating channel has a round, preferably a circular or oval inner cross-section.

A particularly recommended embodiment is characterized in that the heating channel extends in the region of the outer surface of the tube wall. A highly preferred embodiment is characterized in that in the outer surface of the tube wall a longitudinal slot is provided extending along the heating channel, which longitudinal slot connects the heating channel or the interior/the inner space of the heating channel to the outer surface of the tube wall. Due to the longitudinal slot a heating channel is thus so to speak connected to the outer environment of the tube wall. The longitudinal slot is expediently a continuous longitudinal slot over the length of the heating channel.

A highly recommended embodiment is characterized in that a longitudinal slot is designed with the dimensions, or is dimensioned such that the heating element is introducible, preferably can be flipped or latched into the heating channel through the longitudinal slot—preferably by temporary widening of the longitudinal slot. The heating element—preferably in the form of a heating wire—is expediently inserted through the longitudinal slot by application of a compressive force. Preferably this insertion widens the longitudinal slot, and after insertion of the heating element or heating wire the tube wall regions delimiting the longitudinal slot return—preferably under the influence of elastic forces—into their initial position or essentially into their initial position. According to one embodiment, in their initial position these tube wall regions delimiting the longitudinal slot abut on each other so that in this position the longitudinal slot is closed, as it were. Thus the above-mentioned one-hundred-percent containment of the heating element by the material of the tube wall, or the one-hundred-percent extension of the inner wall of the heating element over the inner circumference of the heating channel, will occur. Preferably the heating element or the heating wire is thus introduced or inserted into the heating channel by application of elastic restoring forces of the tube wall regions. It has already been pointed out that according to a particularly recommended embodiment, the heating element is completely accommodated in the heating channel and in the tube wall of the conduit and expediently does not protrude out of the outer surface of the tube wall.—In the above-described embodiment with one-hundred-percent containment, the longitudinal slot is configured closed in the initial position, and upon introduction of the heating element or of the heating wire can correspondingly be opened or widened. According to another embodiment of the present disclosure, the longitudinal slot can also have a slight opening width in its initial position, in particular an opening width of 0.1 to 3 mm, preferably of 0.1 to 2 mm and more preferably of 0.1 to 1 mm.

The heating element is preferably configured as a strand-shaped heating element and is preferably configured in the shape of at least one heating wire. It is also possible that a plurality of mutually twisted heating wires is accommodated in a heating channel as a heating element. Furthermore the at least one heating wire preferably extends along the heating channel in the longitudinal direction or essentially in the longitudinal direction of the conduit.

The diameter D of the heating channel expediently corresponds to 10 to 60%, preferably 15 to 55%, more preferably 20 to 55%, and particularly preferably 25 to 50% of the thickness d of the tube wall. Preferably the diameter D of the heating channel is less than the thickness d of the tube wall. Here according to recommendation the heating channel is disposed in the one-half of the thickness d of the tube wall facing the outer surface. According to a preferred embodiment variant at least 40% of the cross-sectional area of the heating channel, in particular at least 50% or at least 60% of the cross-sectional area of the heating channel is disposed in the one-third of the thickness d of the tube wall facing the outer surface.

Within the context of the present disclosure the heating element or the at least one heating wire is accommodated in the heating channel at least sectionally with clearance. Here the heating element or the heating wire is expediently accommodated in the heating channel with clearance over at least a part of its circumference. It is furthermore within the context of the invention that the heating element or the heating wire is accommodated in the heating channel at least sectionally in a positive-locking manner. The heating element or the heating wire is expediently not accommodated in the heating channel in a materially bonded manner or by friction-lock. In this respect the inventive arrangement of heating element and tube wall differs from a heating element or heating wire injected into the tube wall. Rather, the heating element or the heating wire according to the recommended embodiment is displaceably disposed in the heating channel relative to the heating channel or relative to the inner wall of the heating channel. In principle according to the recommended embodiment of the invention, the heating element or the heating wire could thus be pulled through the heating channel or also pulled out again from the heating channel. On the other hand, the preferably narrow or closed longitudinal slot prevents the heating element from sliding out or falling out of the associated heating channel. According to an alternative embodiment the heating element is accommodated in the heating channel in a clearance-free manner. The heating element is expediently a conductive polymer.

Another preferred embodiment of the present disclosure is characterized in that the heating channel and preferably the heating element accommodated in the heating channel extends parallel or essentially parallel to the longitudinal axis L of the conduit. According to another variant, a heating channel with the heating element or heating wire accommodated therein can also extend corrugation-shaped or meander-shaped along the length of the tube wall. One embodiment is characterized in that the heating channel and preferably also the heating element accommodated in the heating channel is disposed helically in the conduit. Nevertheless the heating channel and at the same time the heating element accommodated therein extends in the longitudinal direction of the conduit.

Another form of the present disclosure is characterized in that at least two heating channels, preferably two heating channels are provided and that at least one heating element, preferably one heating element or one heating wire, is disposed in each heating channel. According to recommendation the at least two heating channels and preferably the heating elements/heating wires accommodated therein are disposed parallel to each other or essentially parallel to each other.

According to another embodiment of the present disclosure the conduit includes, in addition to the described tube wall, at least one casing or protective coating surrounding the tube wall—preferably with a spacing. This protective casing can be, for example, a shaft tube surrounding the tube wall with the inner channel.

Also disclosed is a method for manufacturing a heatable motor vehicle conduit, wherein the conduit is produced with a tube wall and an inner channel surrounded by the tube wall, as well as with at least one heating channel integrated in the tube wall, and wherein in the connection thereto at least one heating element—preferably at least one heating wire—is introduced into the heating channel through the outer surface of the tube wall.—The conduit is expediently produced with the tube wall and the heating channel integrated therein by extrusion of at least one plastic material, preferably of one plastic material. According to recommendation the production or the extrusion of the tube wall is effected in a manner providing that a heating channel integrated into the tube wall is connected via a longitudinal slot to the outer surface of the tube wall. Here the longitudinal slot expediently extends over the length of the heating channel in the longitudinal direction of the conduit.

One form of the method of the present disclosure is characterized in that a heating element—preferably a heating wire—is introduced or inserted through the longitudinal slot into the associated heating channel. The heating element or the heating wire is expediently inserted along the longitudinal slot with application of a radial compressive force into the longitudinal slot. Here the tube wall material delimiting the longitudinal slot is preferably moved or pressed to the side so that the longitudinal slot is at least temporarily widened and the heating element or the heating wire can be introduced into the heating channel. After the introducing or insertion of the heating element/heating wire, the tube wall material delimiting the longitudinal slot expediently returns into its initial position or essentially into its initial position, and specifically according to recommendation under the influence of elastic restoring forces. The introduced heating element or the introduced heating wire then extends along the heating channel and expediently along the longitudinal slot provided on the heating channel. Within the context of the invention the longitudinal slot, as well as the associated heating channel, is produced with an extrusion of the tube wall of the conduit.

The present disclosure is based on the finding that with the inventive heatable motor vehicle conduit a simple and low-complexity introducing or affixing of a heating element is possible. Compared to the coil-shaped windings known from the prior art of a heating wire, complex measures for positioning and affixing of the heating wire are omitted. Using the inventive measures, in particular using an inventive heating channel a highly functionally secure positioning and affixing of the heating element can be achieved. Short-circuits between heating wire sections can be completely avoided. Moreover, the inventive motor vehicle conduit also makes possible a very effective heating of the inner channel, and the heat transfer from a heating element accommodated in an inventive heating channel to the inner channel is simple and possible in a problem-free manner. It is also noteworthy that an inventive heatable motor-vehicle conduit can be manufactured in a simple, low-complexity, and above all cost-effective manner. A particularly simple and cost-effective manufacture results through the extrusion of a tube wall of the inventive conduit with the integrated heating channel and preferably with a longitudinal slot provided on the heating channel. As a result, the present disclosure is characterized by simplicity, low complexity, and low costs.

### BRIEF DESCRIPTION OF THE DRAWINGS

The present disclosure shall be explained in greater detail below on the basis of drawings which show only one exemplary embodiment. The schematic representations are as follows:

FIG. 1 a perspective view of an inventive heatable motor vehicle conduit,

FIG. 2 a cross-section through the object according to FIG. 1, and

FIGS. 3a to c schematically show a sequence of steps of the inventive method for manufacturing the motor vehicle conduit.

### DETAILED DESCRIPTION

The Figures show an inventive motor vehicle conduit 1 for transmission of a not-depicted fluid medium, in particular for transmission of an aqueous urea solution. The conduit 1 includes an inner channel 2 for the transmission of the fluid medium as well as a tube wall 3 surrounding the inner channel 2. In the exemplary embodiment two heating channels 4 extending in the longitudinal direction of the conduit 1 are provided inside the tube wall 3. According to recommendation and in the exemplary embodiment, a heating element 5 extending along the heating channel 4 and in the longitudinal direction of the tube line 1 is disposed in each heating channel 4. Here preferably and in the exemplary embodiment the heating elements 5 are each configured as a heating wire. Preferably and in the exemplary embodiment each heating element 5 or each heating wire is surrounded over more than 95% of its circumference by the inner wall 6 of the respective associated heating channel 4 or by the material of the tube wall 3, and the inner wall 6, formed by the material of the tube wall 3, of the heating channel 4 extends over at least 95% of the inner circumference of the heating channel 4. A heating element 5 or a heating wire thus extends preferably in the longitudinal direction of the associated heating channel 4 and in the longitudinal direction of the inner channel 2 of the tube line 1.

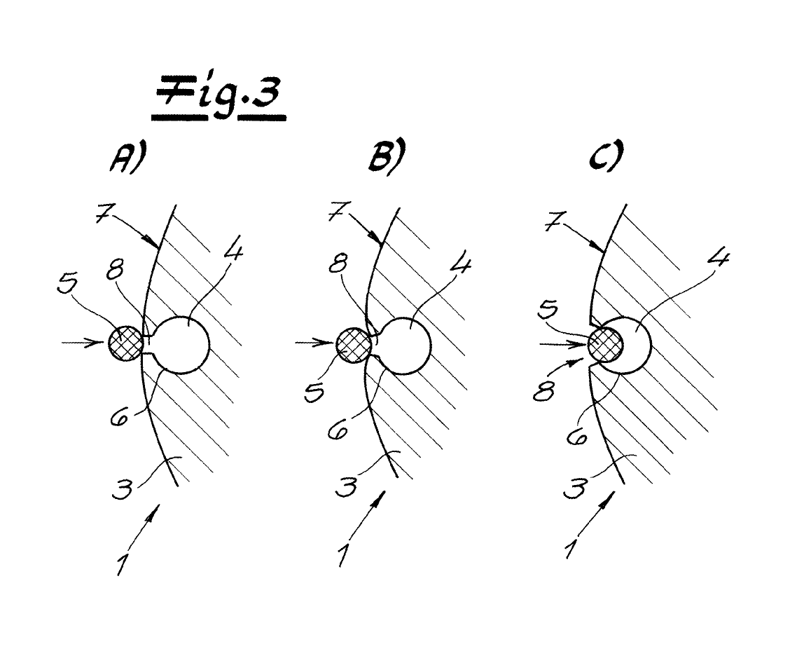

Preferably and in the exemplary embodiment an inventive heating channel 4 is configured as round or circular in cross-section. It is recommended that each heating channel 4—as in the exemplary embodiment according to the Figures—extends along the tube line 1 in the region of the outer surface 7 of tube wall 3. Preferably and in the exemplary embodiment a longitudinal slot 8 extending along a heating channel 4 is provided in the outer surface 7 of the tube wall 3, which longitudinal slot 8 connects the heating channel 4 or the interior of the heating channel 4 to the outer surface 7 of the tube wall 3. Such a longitudinal slot 8 thus connects a heating channel 4 to the outer environment of the tube wall 3. The longitudinal slot 8 is expediently designed with the dimensions or is dimensioned such that the heating element 5 or the heating wire can be pressed or clipped into the heating channel 4 through the longitudinal slot 8, or more preferably and in the exemplary embodiment (see FIG. 3) by temporary widening of the longitudinal slot 8. This embodiment of the invention has proven particularly valuable.

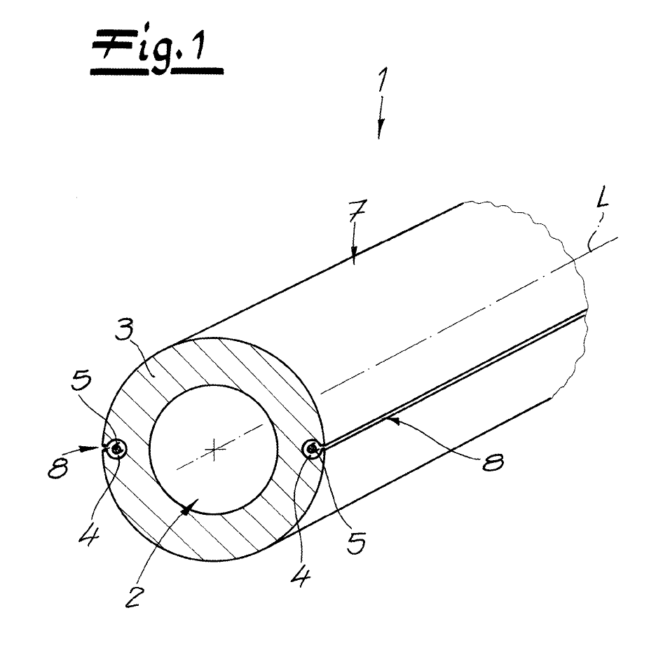

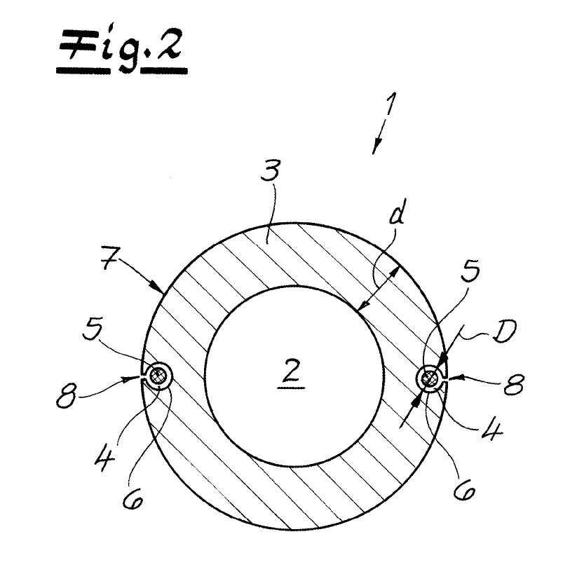

As is depicted in FIG. 3 a heating element 5 or a heating wire is guided to the outer surface 7 of the conduit 1 and then pressed through the longitudinal slot 8 into the associated heating channel 4. In this case, when inserting the heating element 5 the tube wall regions delimiting the longitudinal slot 8 are initially pressed somewhat inward toward the heating channel 4 (see FIG. 3b) and subsequent thereto the longitudinal slot 8 is widened by displacing of these tube wall regions (FIG. 3c). Under the influence of elastic restoring forces the tube wall regions in question then expediently return to their initial position so that the state depicted in FIGS. 1 and 2 is reached. Then the heating element 5 or the heating wire is completely accommodated in the associated heating channel 4 of the tube wall 3. Within the context of the invention the heating element 5 accommodated in the heating channel 4 does not protrude over the outer surface 7 of the tube wall 3.

Expediently and in the exemplary embodiment the diameter D of a heating channel 4 is less than 50% of the thickness d of the tube wall 3. Within the context of the invention the heating element 5 or the heating wire is accommodated in the heating channel 4 at least in sections with a clearance.—According to a preferred embodiment and in the exemplary embodiment a heating channel 4 and preferably also the heating element 5 accommodated in the heating channel 4 extends parallel to the longitudinal axis L of the conduit 1. In the exemplary embodiment two such heating channels 4 are provided with respectively accommodated heating elements 5.

1. Heatable motor-vehicle conduit for transmission of a fluid medium, wherein the conduit includes an inner channel for the transmission of the fluid medium and a tube wall surrounding the inner channel, wherein inside the tube wall at least one heating channel is provided extending in the longitudinal direction of the conduit, wherein at least one heating element extending along the heating channel is disposed in the heating channel, wherein the heating element is surrounded over at least 85% of its circumference by the inner wall of the heating channel and by the material of the tube wall.

2. Heatable motor-vehicle conduit according to claim 1, wherein the inner wall of the heating channel, which inner wall is formed by the material of the tube wall, of the inner circumference of the heating channel.

3. Heatable motor-vehicle conduit according to claim 1, wherein the heating channel extends in a region of the outer surface of the tube wall, and wherein a longitudinal slot extending along the heating channel is provided in the outer surface of the tube wall, which longitudinal slot connects the heating channel to the outer surface of the tube wall.

4. Heatable motor-vehicle conduit according to claim 3, wherein the longitudinal slot is dimensioned such that the heating element can be in introduced into the heating channel through the longitudinal slot.

5. Heatable motor-vehicle conduit according to claim 1, wherein the heating element is configured as a strand-shaped heating element in the form of at least one heating wire.

6. Heatable motor-vehicle conduit according to claim 1, wherein the diameter D of the heating channel corresponds to 10 to 60% of the thickness d of the tube wall.

7. Heatable motor-vehicle conduit according to claim 1, wherein the heating element is received in the heating channel at least sectionally with clearance.

8. Heatable motor-vehicle conduit according to claim 1, wherein the heating channel and preferably also the heating element received in the heating channel extends parallel or essentially parallel to the longitudinal axis L of the conduit.

9. Heatable motor-vehicle conduit according to claim 1 to 7, wherein the heating channel and the heating element received in the heating channel are disposed helically in the tube wall.

10. Heatable motor-vehicle conduit according to claim 1, wherein at least two heating channels are provided, and wherein at least one heating element is disposed in each heating channel.

11. Heatable motor-vehicle conduit according to claim 10, wherein the at least two heating channels are disposed essentially parallel to one another.

12. Method for manufacturing a heatable motor-vehicle conduit according to claim 1, wherein first the tube wall with the inner channel surrounded by the tube wall and with at least one heating channel integrated into the tube wall is generated, and wherein subsequently thereto at least one heating element is pressed-in into the heating channel through the outer surface of the tube wall.

13. Method according to claim 12, wherein the tube wall with the at least one heating channel integrated therein is generated by extrusion of at least one plastic material.

14. Method according to claim 12, wherein the generating of the tube wall is effected with dimensions such that a heating channel integrated into the tube wall is connected via a longitudinal slot to the outer surface of the tube wall.

15. Method according to claim 14, wherein the heating element is introduced or pressed into the heating channel through the longitudinal slot.

16. Heatable motor-vehicle conduit according to claim 1, wherein the heating element is surrounded over at least 95% of its circumference by the inner wall of the heating channel and by the material of the tube wall.

17. Heatable motor-vehicle conduit according to claim 2, the inner wall of the heating channel, which inner wall is formed by the material of the tube wall, extends over at least 97% of the inner circumference of the heating channel.

18. Heatable motor-vehicle conduit according to claim 3, wherein the longitudinal slot is dimensioned such that the heating element can be introduced by latching into the heating channel through temporary widening of the longitudinal slot.

19. Heatable motor-vehicle conduit according to claim 6, wherein the diameter D of the heating channel corresponds to 25 to 50% of the thickness d of the tube wall.
